(19) United States
(12) Patent Application Publication
(10) Pub. No.: US 2012/0215139 A1
(43) Pub. Date: Aug. 23, 2012

(54) FAR INFRARED SWEATING BOX

(75) Inventor: Yuehong Pan, Shenzhen (CN)

(73) Assignee: Shenzhen Anpan Technology Co., Ltd.

(21) Appl. No.: 13/377,732

(22) PCT Filed: May 7, 2010
(86) PCT No.: PCT/CN2010/072507

§ 371 Date: Dec. 12, 2011

(30) Foreign Application Priority Data
Jun. 17, 2009 (CN) 200920159341.8

(51) Int. Cl. A61H 1/00

(52) U.S. Cl. 601/15

(57) ABSTRACT

A far infrared sweating box includes a box body and a heater. Said box body includes supporting members and folding members. Said supporting members constitute the frames of the box body. The folding members connect with the supporting members to form the box body. Since the box body of the far infrared sweating box includes supporting members and folding members, it can be folded so as to decrease the volume of the box and to be more portable.

The present application is the national phase of International Application No. PCT/CN2010/072507, entitled “FAR INFRARED SWEATING BOX”, filed on May 7, 2010, which claims benefit of the priority to CN application No. 200920159341.8 titled “FAR INFRARED SWEATING BOX”, filed with the Chinese State Intellectual Property Office on Jun. 17, 2009. The entire disclosure thereof is incorporated herein by reference.

### BACKGROUND

1. Field of the Invention

The disclosure relates to healthcare and therapy technology, and more specifically to a far infrared sweat steaming box.

2. Discussion of the Background Art

At present, the far infrared technology has been used widely. Since far infrared ray having a wavelength in a range from 6 μm to 15 μm may permeate the skin and subcutaneous tissues of human body so as to elevate the temperature of subcutaneous tissues, expand the capillary, promote the blood circulation, strengthen the body's metabolism, remove harmful substances in the blood, improve the regeneration ability and antispasmodic ability of tissues and so on, thereby having the treatment and healthcare function.

Chinese Utility Model No. ZL 200720201146.8 discloses a far infrared sweat steaming box, which comprises a box body and a heating surface paved in the box body. The heating surface is jointed with a high-radiation far infrared material layer, and the high-radiation far infrared material is selected from any of charcoal, medical stone, bowlder, germanite, tourmaline and magnet. The high-radiation far infrared material layer is tabular, spaced strip-shaped, close-set block-shaped, sheet-shaped or lattice-shaped, thereby enabling the far infrared radiation to be sufficient, and the cure and healthcare effect to be fine. The far infrared sweat steaming box is more suitable for gynaecological disease, rheumatism, diabetes mellitus, lymphatic system disease, arthralgia, courbature and traumatic injury patients.

For the utility model, the inventor of the present disclosure found that the box body of the far infrared sweat steaming box is large and fixed, which is inconvenient for carry.

### SUMMARY

The technical problem to be solved by the embodiments of the disclosure is to provide a far infrared sweat steaming box which is convenient for carry.

The embodiments of the disclosure provide a far infrared sweat steaming box including a box body and a heater.

The box body includes a supporting component and a foldable component.

The supporting component forms a frame of the box body, and the foldable component is connected with the supporting component to form the box body.

Optionally, the supporting component includes a plurality of plates, and the foldable component includes a foldable connection component for connecting the plurality of plates. The plates may be folded via the foldable connection component.

Or, the supporting component includes a skeleton, and the foldable component includes a foldable outer cover. The skeleton is foldable and forms the frame of the box body. The foldable outer cover is covered on the skeleton to form the box body.

Optionally, the plate is a hollow plate.

Optionally, the foldable outer cover is a cloth having an inner wall coated with infrared reflection material.

Further, the far infrared sweat steaming box further includes a spectrum energy multiplier disposed within the box body.

Further, the far infrared sweat steaming box further includes a chair disposed within the box body.

The above technical solutions have the following advantageous effects. For example, since the box body of the far infrared sweat steaming box includes the supporting component and the foldable component, the volume of the far infrared sweat steaming box may be decreased by folding the box body, which is convenient for carry.

### BRIEF DESCRIPTION OF THE DRAWINGS

FIG. 1 is a schematic structural view of the far infrared sweat steaming box according to the disclosure; and

FIGS. 2a and b is a schematic view of the box body of the far infrared sweat steaming box according to the disclosure, illustrating the folding of the box body.

### DETAILED DESCRIPTION OF THE PREFERRED EMBODIMENT

Hereinafter, the disclosure is further described by way of the embodiments and drawings. The same combination of numerical reference and designation used in the embodiments of the disclosure indicates the same structure, unless there is a particular explanation. When referring to one figure, other associated figures including the same numerical reference may also be referred to, which will not be pointed out in the following description to the embodiment of the disclosure by referring to figures.

The technical problem to be solved by the embodiments of the disclosure is to provide a far infrared sweat steaming box which is convenient for carry. The far infrared sweat steaming box includes a box body and a heater.

The box body includes a supporting component and a foldable component.

The supporting component forms a frame of the box body. The box body is formed by connecting the foldable component and the supporting component.

Two specific implementation manners for folding the box body will be given below.

The supporting component includes a plurality of plates, and the foldable component includes a foldable connection component(s) for connecting the plurality of plates. The plates may be folded via the foldable connection component(s).

Or, the supporting component includes a skeleton, and the foldable component includes a foldable outer cover. The skeleton may be foldable, and may form the frame of the box body. The foldable outer cover is covered on the skeleton so as to form the box body.

Since the box body of the far infrared sweat steaming box includes the supporting component and the foldable component, the volume of the far infrared sweat steaming box may be decreased by folding the box body, which is convenient for carry.

Optionally, the plate is a hollow plate. The use of the hollow plate may lessen the weight of the box body, so that the box may be carried easily.

Optionally, infrared reflection material may be provided on the inner wall of the plate or the inner wall of the outer cover. The use of the infrared reflection material may relieve the phenomenon that the plate or the outer cover absorbs infrared ray, which may reduce the waste of energy sources, and increase the utilization rate of energy sources.

More specifically, the infrared reflection material is silver cloth. Of cause, using other types of infrared reflection materials doesn't affect the implementation of the disclosure. The silver cloth just is an example of infrared reflection materials, and it shouldn't be understood to limit the disclosure.

Optionally, far infrared material of the heater is far infrared carbon pulp alloy. The heating element made of far infrared carbon pulp alloy material has an electricity-heat conversion rate up to 99%, approximating 100%, and has a higher utilization rate of energy sources than that made of charcoal, medical stone, bowlder, germanite, tourmaline or magnet and so on. Compared with the conventional heating material, using the carbon pulp alloy material may reduce the amount of the used material, which greatly economizes resources.

Further, the far infrared sweat steaming box further includes a spectrum energy multiplier disposed in the box body. In the spectrum energy multiplier, a resistance with positive temperature coefficient (PTC) whose surface is coated with far infrared materials may serve as the heating element, which has high energy conversion efficiency, and easily achieves the precise control of energy. A blower may be installed within the spectrum energy multiplier in order to circulate the energy, and thus improve the energy uniformity of the system. The application of the spectrum energy multiplier may increase the conversion speed of energy and increase the conversion efficiency of energy.

Further, the far infrared sweat steaming box further includes a chair disposed within the box body. By providing the chair in the box body, the user may be seated when using the far infrared sweat steaming box, and feel more comfortable than the case of standing, squatting and so on, which may improve the user experience.

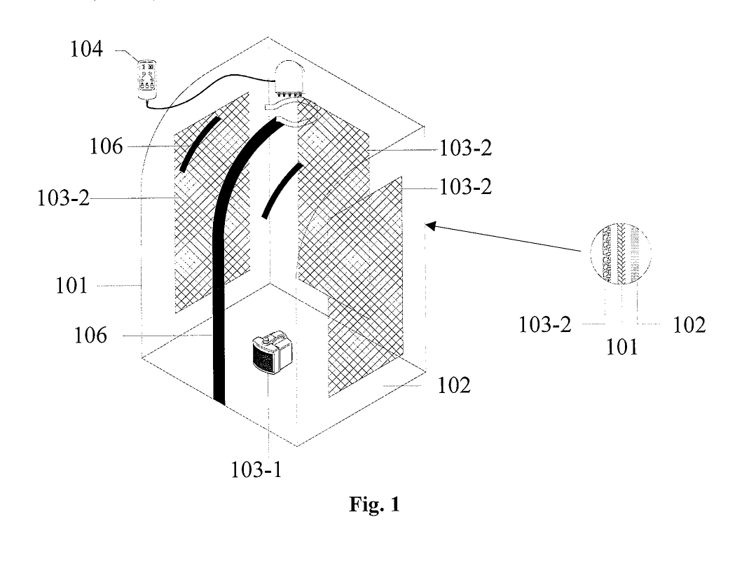

More specifically, as shown in FIG. 1, a schematic structural view of the far infrared sweat steaming box according to the embodiment of the disclosure is shown.

The far infrared sweat steaming box includes a skeleton 101, a heating system, a control system 104 and an outer cover 102 configured to cover on the skeleton 101. A closed room is formed by the outer cover 102 and the skeleton 101. A chair 105 is provided in the closed room. Zippers 106 are provided on the outer cover 102 in order to allow a user to come in and out and allow the user's head and hands to be stretched out. When the sweat steaming box is used, the head and hands of the user may be stretched out from the sweat steaming box. The heating system includes a spectrum energy multiplier 103-1 located in the closed room and heating plates 103-2 located on the inner walls of the closed room. The number of the heating plates 103-2 shown in FIG. 1 is three. According to the actual conditions, the number of the heating plates 103-2 may be varied, which doesn't affect the implementation of the disclosure. It should be noted that the embodiment is illustrative, and not intended to limit the disclosure. The control system 104 is used to control the heating system, for example the heating power thereof. In addition, as shown in the circled part at the right of FIG. 1, for the sweat steaming box, the heating plates 103-2, the skeleton 101 and the outer cover 102 are arranged from the inside to the outside in this order.

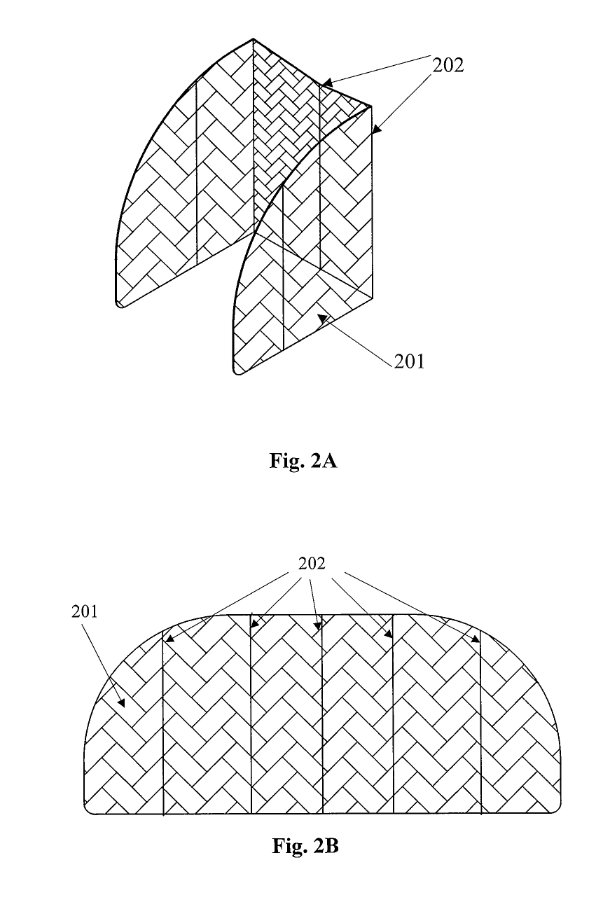

The following description will be made taking a hollow plate as an example of the box body. As shown in FIGS. 2A and 2B, FIG. 2A is a schematic view of the box body of the far infrared sweat steaming box according to the disclosure when being folded, and FIG. 2B is a schematic view of the box body shown in FIG. 2A when being unfolded.

The box body includes hollow plates 201. Foldable connection components 202 may be provided on the hollow plates 201, such that the hollow plates 201 may be folded via the foldable connection components 202. Thus, the box body may be folded by folding the hollow plates 201.

If the box body includes a skeleton and an outer cover, the outer cover may be a cloth. If the skeleton may be folded or disassembled, the whole box body may be folded.

Only the preferred embodiments of the disclosure have been described. It should be noted that there is a limitation in the word expression, but the specific structure is unlimited objectively. Thus, it is appreciated that many improvements and modifications may be made by those skilled in the art without departing from the principle of the disclosure, and these improvements and modifications should be deemed to fall into the protection scope of the disclosure.

1. A far infrared sweat steaming box comprising a box body and a heater, wherein
the box body includes a supporting component and a foldable component,
the supporting component forms a frame of the box body, and the foldable component is connected with the supporting component to form the box body.

2. The far infrared sweat steaming box according to claim 1, wherein
the supporting component includes a plurality of plates, the foldable component includes a foldable connection component for connecting the plurality of plates, the plates are foldable via the foldable connection component; or
the supporting component includes a skeleton, the foldable component includes a foldable outer cover; the skeleton is foldable; the skeleton forms the frame of the box body, the foldable outer cover is covered on the skeleton so as to form the box body.

3. The far infrared sweat steaming box according to claim 2, wherein the plate is a hollow plate.

4. The far infrared sweat steaming box according to claim 2, wherein the foldable outer cover is a cloth having an inner wall coated with infrared reflection material.

5. The far infrared sweat steaming box according to any of claim 1, further comprising a spectrum energy multiplier disposed within the box body.

6. The far infrared sweat steaming box according to any of claim 1, further comprising a chair disposed within the box body.

7. The far infrared sweat steaming box according to claim 2, further comprising a spectrum energy multiplier disposed within the box body.

8. The far infrared sweat steaming box according to claim 3, further comprising a spectrum energy multiplier disposed within the box body.

9. The far infrared sweat steaming box according to claim 4, further comprising a spectrum energy multiplier disposed within the box body.

10. The far infrared sweat steaming box according to claim 2, further comprising a chair disposed within the box body.

11. The far infrared sweat steaming box according to claim 3, further comprising a chair disposed within the box body.

12. The far infrared sweat steaming box according to claim 4, further comprising a chair disposed within the box body.
